(19) United States
(12) Patent Application Publication
(10) Pub. No.: US 2012/0324147 A1
(43) Pub. Date: Dec. 20, 2012

(54) Read While Write Method for Serial Peripheral Interface Flash Memory

(76) Inventor: Che-Heng Lai, Kaohsiung City (TW)

(21) Appl. No.: 13/228,473

(22) Filed: Sep. 9, 2011

(30) Foreign Application Priority Data
Jun. 16, 2011 (TW) 100121023

(51) Int. Cl. G06F 12/02

(52) U.S. Cl. 711/103; 711/E12.008

(57) ABSTRACT

The present invention discloses a RWW method for SPI flash memory. The RWW method comprises executing a write command, halting the write command during receiving a read command, executing the reading, and internally restoring the write command when completing the read command.

### BACKGROUND OF THE INVENTION

1. Field of the Invention

The present invention relates to a read while write (RWW) method for a serial peripheral interface (SPI) flash memory, and more particularly, to a RWW method for a SPI flash memory and capable of instantaneously execute a read command while executing a write command.

2. Description of the Prior Art

In general, flash memories can be classified into parallel flash memories and serial peripheral interface (SPI) flash memories. Since an SPI flash memory requires fewer transmission lines and pins, the circuit is simpler and cost is lower. Therefore, the SPI flash memory becomes a main trend.

In a parallel flash memory, which can utilize memory to record the address of memory executing a read command, it reads and writes in parallel when determining the memory address desired to be written is different from the memory address that is currently read. Therefore, a host can simultaneously read and write different memory blocks to achieve the function of read while write (RWW). In other words, the parallel flash memory can execute a write command at a memory block and simultaneously execute a read command at another memory block.

In comparison, a SPI flash memory can not simultaneously execute a read command and a write command. Therefore, the SPI flash memory ignores a read command internally while executing a write command. Besides, a host sends a read or write command comprising a first part for indicating a read or write operation (e.g. 8 clocks) and a second part for indicating a memory address (e.g. 24 clocks), such that the SPI flash memory can sequentially execute the read or write operations according to the indicated memory address, which is different from the parallel flash memory uses exclusive transmission lines to execute read or write operations toward specific memory blocks.

In such situation, if the conventional host desires to read the SPI flash memory when the SPI flash memory executes a write command, the host needs to wait first then sends a read commend after the SPI flash memory completes the write command. However, the host may have to wait for a considerable time according to the above method, and thus can not read the SPI flash memory instantaneously. Thus, there is a need to improve the prior art.

### SUMMARY OF THE INVENTION

It is therefore a primary objective of the present invention to provide a read while write (RWW) method for a SPI flash memory, such that the SPI flash memory can instantaneously execute a read command while executing a write command.

The present invention further discloses a RWW method for a SPI flash memory, the RWW method comprises executing a write command, halting the write command while receiving a read command, executing the read command and internally restoring the write command when completing the read command.

The present invention further discloses a SPI flash memory for executing the above RWW methods.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 illustrates a schematic diagram of a SPI flash memory.

FIG. 2 illustrates a schematic diagram of a suspend read process.

FIG. 3 illustrates a schematic diagram of a SPI flash memory according to an embodiment of the present invention.

FIG. 4 illustrates a schematic diagram of a read while write (RWW) process.

### DETAILED DESCRIPTION

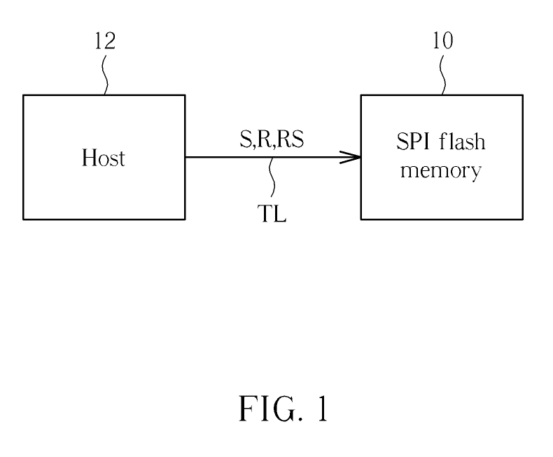

Please refer to FIG. 1, which illustrates a schematic diagram of a SPI flash memory 10. As shown in FIG. 1, a host 12 and the SPI flash memory 10 are connected via a transmission line TL and a pin of the SPI flash memory 10, to transmit commands for controlling operations of the SPI flash memory 10. The SPI flash memory internally ignores a read command if the SPI flash memory 10 receives the read command while executing a write command.

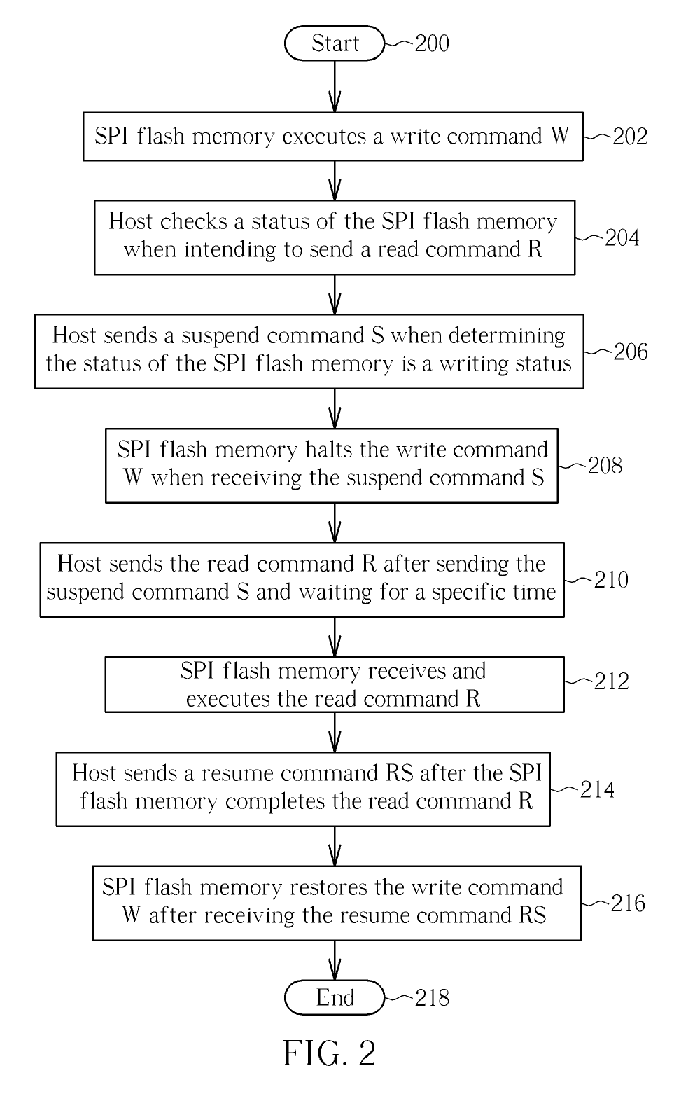

In detail, a suspend read process 20 as shown in FIG. 2 is utilized by the host 12 and the SPI flash memory 10, such that the SPI flash memory 10 can execute a read command during executing a write command. The suspend read process 20 includes following steps:

Step 200: Start

Step 202: The SPI flash memory 10 executes a write command W.

Step 204: The host 12 checks a status of the SPI flash memory 10 when intending to send a read command R.

Step 206: The host 12 sends a suspend command S when determining the status of the SPI flash memory 10 is a writing status.

Step 208: The SPI flash memory 10 halts the write command W when receiving the suspend command S.

Step 210: The host 12 sends the read command R after sending the suspend command S and waiting for a specific time.

Step 212: The SPI flash memory 10 receives and executes the read command R.

Step 214: The host 12 sends a resume command RS after the SPI flash memory 10 completes the read command R.

Step 216: The SPI flash memory 10 restores the write command W after receiving the resume command RS.

Step 218: End.

As can be seen from the suspend read process 20, since the SPI flash memory 10 internally ignores the read command R if the host 12 directly sends the read command R while the SPI flash memory 10 executes the write command W. Therefore, the host 12 checks a status of SPI flash memory before intending to send the read command R. The host 12 directly sends the read command R if determining the status of the SPI flash memory 10 is not a writing status. Conversely, if the host 12 determines the status of the SPI flash memory 10 is a writing status, the host 12 has to send a suspend command S first, such that the SPI flash memory 10 can halt the write command W lest the read command R is ignored by the SPI flash memory 10.

Noticeably, since the SPI flash memory 10 first halts and records an internal writing status, then discharges an internal high voltage level to zero, and finally releases an internal data bus to complete operations of halting the write command W. Therefore, after sending the suspend command S, the host 12 has to wait for a specific time (about 20 μs) until the above operations can be completed, and then sends the read command R to the SPI flash memory 10. At this moment, since the SPI flash memory 10 has halted the write command W, the SPI flash memory 10 can receive and execute the read command R instead of ignoring the read command R. Finally, after the SPI flash memory 10 completes the read command R, the host 12 sends the restore command RS, such that the SPI flash memory 10 can restore the write command W according to the record of the internal writing status, so as to complete the write command W. As a result, by the suspend read process 20, the SPI flash memory 10 can execute the read command R without completing the write command W first.

However, as can be seen from the above, the commands which the host 12 sends to the SPI flash memory 10 are too complicated, during the suspend read process 20. Moreover, since the SPI flash memory 10 internally ignores the read command R while executing the write command W, the host 12 has to check the status of the SPI flash memory 10 first and waits for the specific time until the operations of halting the write command W is completed after sending the suspend command S. Afterwards, the host 12 can send the read command R to the SPI flash memory 10 for executing the read command R. Besides, an interval between the resume command RS and a following suspend command is required to be at least a specific time, which means the host 12 has to further wait for the specific time other than the above execution time of sending the read command R, to send a following read command. In other words, by the suspend read process 20, the host 12 still has to wait a considerable time and can not instantaneously read the SPI flash memory 10

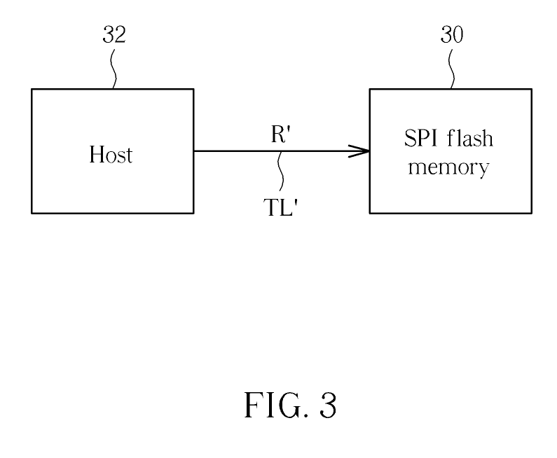

On the other hand, please refer to FIG. 3, which illustrates a schematic diagram of a SPI flash memory 30 according to an embodiment of the present invention. As shown in FIG. 3, a host 32 and the SPI flash memory 30 are connected via a transmission line TL′ and a pin of the SPI flash memory 30, to transmit commands for controlling operations of the SPI flash memory 30. Main difference between the SPI flash memory 30 and the SPI flash memory 10 is that the SPI flash memory 30 does not ignore a read command internally if the SPI flash memory 30 receives a read command while executing a write command.

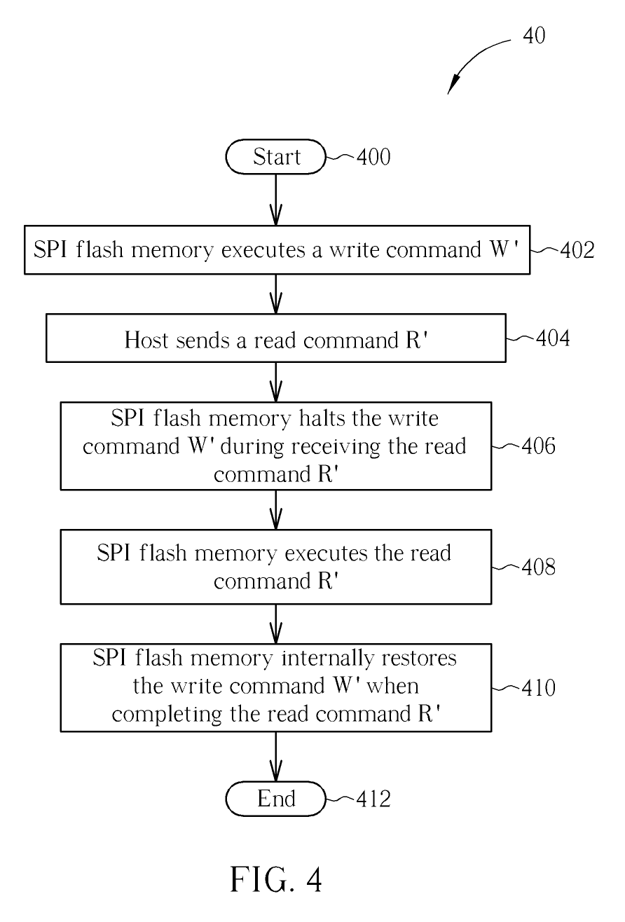

In detail, the host 32 and the SPI flash memory 30 use a read while write (RWW) process 40, as shown in FIG. 4, such that the SPI flash memory 30 executes a read command while executing a write command. The step of the RWW process 40 comprises:

Step 400: Start.

Step 402: The SPI flash memory 30 executes a write command W′.

Step 404: The host 32 sends a read command R′.

Step 406: The SPI flash memory 30 halts the write command W′ during receiving the read command R′.

Step 408: The SPI flash memory 30 executes the read command R′.

Step 410: The SPI flash memory 30 internally restores the write command W′ when completing the read command R′.

Step 412: End.

As can be seen from the RWW process 40, since the SPI flash memory 30 does not internally ignore the read command R′ if the host 32 directly sends the read command R′ to the SPI flash memory 30 while the SPI flash memory 30 executes the write command W′, the host 32 does not check the status of the SPI flash memory 30 before sending the read command R′ to the SPI flash memory 30, but directly sends the read command R′. Then, the SPI flash memory 30 first halts the write command W′ during receiving the read command R′, and then executes the read command R′. The SPI flash memory 30 internally restores the write command W′ after completing the read command R′. As a result, by the RWW process 40, the SPI flash memory 30 does not have to complete the write command W′ first and can execute the read command R′ instantaneously. Besides, the host 32 does not have to transmit complex commands to the SPI flash memory 30 and can instantaneously read the SPI flash memory 30 without waiting.

In detail, the read command R′ includes a first part for indicating a read operation (e.g. 8 clocks) and a second part for indicating a memory address (e.g. 24 clocks). When determining current received clocks are the first part of the read command R′ for indicating the read operation, the SPI flash memory 30 halts the write command during receiving the second part of the read command R′ for indicating the memory address. In such situation, since the SPI flash memory 30 halts the write command W′ while receiving the second part of read command for indicating the memory address and then starts to execute the read command R′, a required execution time is a same that when the SPI flash memory 30 does not execute the write command W′, i.e. the SPI flash memory 30 has to complete receiving the first part for indicating the read operation and the second part for indicating the memory address of the read command R′ and then starts to execute the read command R′. As a result, by the RWW process 40, the host 32 can instantaneously read SPI flash memory without waiting.

Noticeably, the above SPI flash memory 30 halts and records an internal writing status first, then discharges a high voltage level to zero and finally releases an internal data bus for the read command R′. Therefore, the SPI flash memory 30 can internally restore the write command W′ according to the internal writing status when completing the read command R′. To sum up, by the RWW process 40, the host 32 does not have to transmit complex commands to the SPI flash memory 30.

Noticeably, main spirit of present invention is that if the SPI flash memory 30 receives a read command while executing a write command, the SPI flash memory 30 does not internally ignore the read command and halts the write command during receiving the second part of the read command for indicating a memory address. Therefore, the SPI flash memory 30 does not need complex commands and can instantaneously execute the read command without waiting. Those skilled in the art can make modifications or alterations accordingly. For example, in hardware realization, the RWW process 40 can be transformed into a program by using software, firmware, etc., such that a SPI flash memory and a host can execute the steps of the RWW process 40. The method of converting the RWW progress 40 into proper programs and realizing corresponding devices should be well known to those skilled in the art.

In the prior art, since a SPI flash memory internally ignores a read command while executing a write command, when a host desires to send a read command to the SPI flash memory while the SPI flash memory executes a write command, the host has to wait until the SPI flash memory completes the write command and then sends the read command to the SPI flash memory for execution. Therefore, the host has to wait for a considerable time and can not instantaneously read the SPI flash memory. On the other hand, by the RWW process 20, although the SPI flash memory 10 can execute the read command R without completing the write command W, the commands are too complex and the SPI flash memory 10 still has to wait for a considerable time. In comparison, by the RWW process 40, the SPI flash memory 30 can receive the read command R′ while executing the write command W′ and halt the write command W′ during receiving the read command R′, and then executes the read command R′. Therefore, the SPI flash memory 30 does not need complex commands and can instantaneously execute the read command R′ without waiting.

To sum up, the present invention does not need complex commands and can instantaneously execute a read command while the SPI flash memory 30 executing a write command.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A read during write (RWW) method for a serial peripheral interface (SPI) flash memory, the RWW method comprising:
executing a write command;
halting the write command during receiving a read command;
executing the read command; and
restoring the write command internally when completing the read command.

2. The RWW method of claim 1, wherein a host does not check a status of the SPI flash memory before sending the read command to the SPI flash memory.

3. The RWW method of claim 1, wherein the read command comprises a first part for indicating a read operation and a second part for indicating a memory address, and the step of halting the write command during receiving the read command comprises:
determining the received clocks are the first part of read command for indicating the read operation; and
halting the write command during receiving the second part of the read command for indicating the memory address.

4. The RWW method of claim 1, wherein the step of halting the write command comprises:
halting and recording an internal writing status;
discharging internal high voltage levels to zero; and
releasing an internal data bus for the read command.

5. The RWW method of claim 4, wherein the step of restoring the write command internally comprises:
restoring the write command internally according to the internal writing status.

6. A serial peripheral interface (SPI) flash memory for executing the read during write (RWW) method of claim 1.
